(19) United States
(12) Patent Application Publication
(10) Pub. No.: US 2019/0121745 A1
(43) Pub. Date: Apr. 25, 2019

(54) REMAPPING VIRTUAL DEVICES FOR VIRTUAL MACHINES

(71) Applicant: Microsoft Technology Licensing, LLC, Redmond, WA (US)

(72) Inventor: Hadden Mark Hoppert, Bellevue, WA (US)

(73) Assignee: Microsoft Technology Licensing, LLC

(21) Appl. No.: 15/789,861

(22) Filed: Oct. 20, 2017

(51) Int. Cl. G06F 12/1036; G06F 12/1009; G06F 9/455

(52) U.S. Cl. CPC G06F 12/1036; G06F 12/1009; G06F 2009/45583; G06F 2212/656; G06F 2212/657; G06F 9/45558

(57) ABSTRACT

Embodiments relate to removing, or replacing with an emulator, a physical hardware device that backs a virtual device of a virtual machine (VM), and doing so while the VM and a guest operating system therein remain live and continue executing. In the case of removing the physical hardware device, the physical hardware device stops backing the virtual hardware device while the guest operating system continues to execute and have access to the virtual device. Disruption of the guest operating system may be avoided using techniques described herein. In the case of replacing the physical hardware device with an emulator, the emulator serves as a placeholder for the physical hardware device and allows the guest operating system to continue interacting with the virtual device without degradation of functionality. Removal of the physical hardware device and/or remapping the virtual device to an emulator may be transparent to the guest operating system.

### BACKGROUND

Among the many forms of computer virtualization, machine or system virtualization has become common due to many known advantages. System virtualization involves abstracting the hardware resources of a computer and presenting the computer as virtual machines. A layer of software referred to as a hypervisor or virtual machine monitor (VMM) runs directly on the hardware of a computer. The hypervisor manages access to the hardware of the computer by virtual machines (VMs), which are also known as partitions, domains, or guests. Each VM is a software environment or construct capable of hosting its own guest operating system. The hypervisor manages sharing of the computer's hardware, including processing hardware and devices, by the VMs. The presence of a layer of software—the hypervisor—between the guest operating system and the computer hardware is mostly transparent to the guest operating system.

Guest software in a VM interacts with the host's hardware through a hypervisor or virtualization layer. The guest issues requests to virtual hardware or virtual devices, the requests typically flow through a high-speed software channel between the VM and the virtualization layer, which matches the requests with the physical devices that back the VM's virtual devices. A virtualization layer typically receives a VM's requests through a logical/software channel, queues the requests, and directs the requests to the appropriate physical hardware. The guest may not be aware of the virtualization layer, but the virtualization layer introduces overhead in its handling of the guest's requests. For example, dequeuing requests, mapping requests to backing hardware, passing the requests to the backing hardware, and providing results to the VM are typical overhead operations that a virtualization layer might incur.

The virtualization layer provides physical devices to VMs as virtual devices by maintaining indirection mappings between physical devices and virtual devices. This enables transparent sharing of hardware devices among VMs, and each VM appears to have its own device (virtual). In addition to virtualizing physical devices, most machine virtualization systems have functionality to control the execution state of VMs. Typical operations to control a VM's state include pausing, saving, restoring, migrating, and the like. Such operations are particularly useful in cloud environments. A cloud provider might need to alter the state of a VM or its host transparently to the tenant or customer. For instance, a host machine might require a security update to the host/virtualization software. As only the inventor has appreciated, rather than informing a tenant or customer that a VM needs to be saved or shut down to allow a reboot of the host, the cloud provider would prefer to be able to suspend a tenant's VM transparently so that the host can be updated and rebooted without significantly interfering with operations of the tenant's VM and without requiring action by the tenant. If a physical device is mapped into a VM, the VM can't be paused or serviced because the physical device could be writing/reading from the memory (using direct memory access (DMA), for instance).

The inventor alone has appreciated that moving a VM's virtual device to emulation may facilitate a pause/servicing event. Since everything is potentially synchronized, the CPU is driving all interactions, and the full and complete VM state can be saved (otherwise it can be difficult or impossible to save the state of a physical device while it is running). The inventor has also appreciated that if it is guaranteed that that emulation is in effect, the VM can be moved to a host that doesn't have the correct hardware. The VM will likely be slower, but will still be functional. Thus, temporary moves for servicing may be possible, where the VM is then moved back to a host with the physical hardware device that is being emulated. Furthermore, emulation may be performed over the long-term if the benefits of the move outweigh the degradation in performance.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments relate to removing, or replacing with an emulator, a physical hardware device that backs a virtual device of a virtual machine (VM), and doing so while the VM and a guest operating system therein remain live and continue executing. In the case of removing the physical hardware device, the physical hardware device stops backing the virtual hardware device while the guest operating system continues to execute and have access to the virtual device. Disruption of the guest operating system may be avoided using techniques described herein. In the case of replacing the physical hardware device with an emulator, the emulator serves as a placeholder for the physical hardware device and allows the guest operating system to continue interacting with the virtual device with perhaps little or no degradation of functionality. Removal of the physical hardware device or remapping the virtual device to an emulator may be transparent to the guest operating system.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows an example virtualization environment that includes a known type of hypervisor.

FIG. 2 shows an example of physical devices mapped to virtual devices.

FIG. 3 shows a process for replacing a physical device J with an emulator in a way that is transparent to a guest operating system.

FIG. 4 shows a virtualization layer replacing the physical device J with an emulator.

FIG. 5 shows details of the computing device on which embodiments described above may be implemented.

### DETAILED DESCRIPTION

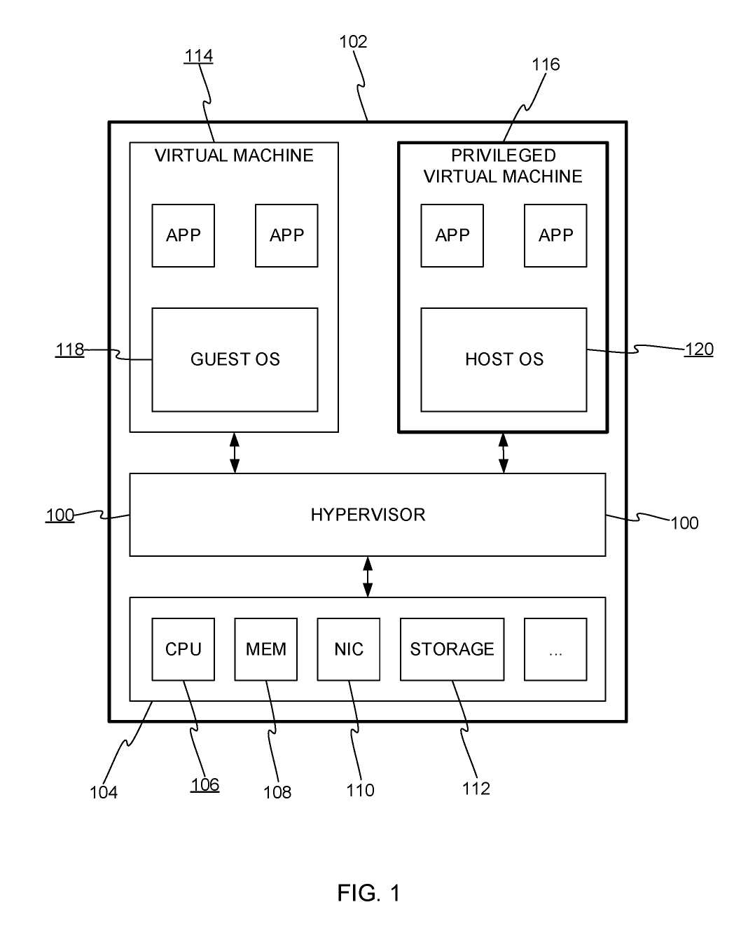

FIG. 1 shows an example virtualization environment that includes a known type of hypervisor 100. A computer 102 has hardware 104, including a central processing unit (CPU) 106, memory 108, a network interface card (NIC) 110, non-volatile storage 112, and other components not shown, such as a bus, a display and/or display adapter, etc. The hypervisor 100 manages and facilitates execution of virtual machines (VMs) 114, 116. Each VM 114, 116 typically has virtualized devices including a virtual disk within which a guest/host operating system 118, 120 is stored. Machine or system virtualization is provided by the hypervisor 100 cooperating with a host operating system 120 that executes in a privileged VM 116.

The tasks of virtualization may be distributed between the hypervisor 100 and the host operating system 120 in known ways. In some cases, the host operating system 120 might consist of only minimal virtualization elements such as tools and user interfaces for managing the hypervisor 100. In other cases, the host operating system 120 might include one or more of: device virtualization management, inter-VM communication facilities, running device drivers, starting, or stopping other VMs. In some embodiments, virtualization may mostly take place within the hypervisor kernel (or a virtualization module that plugs into a stock kernel) and there is no privileged VM 116. Any of the variations mentioned above may be referred to as a virtualization layer.

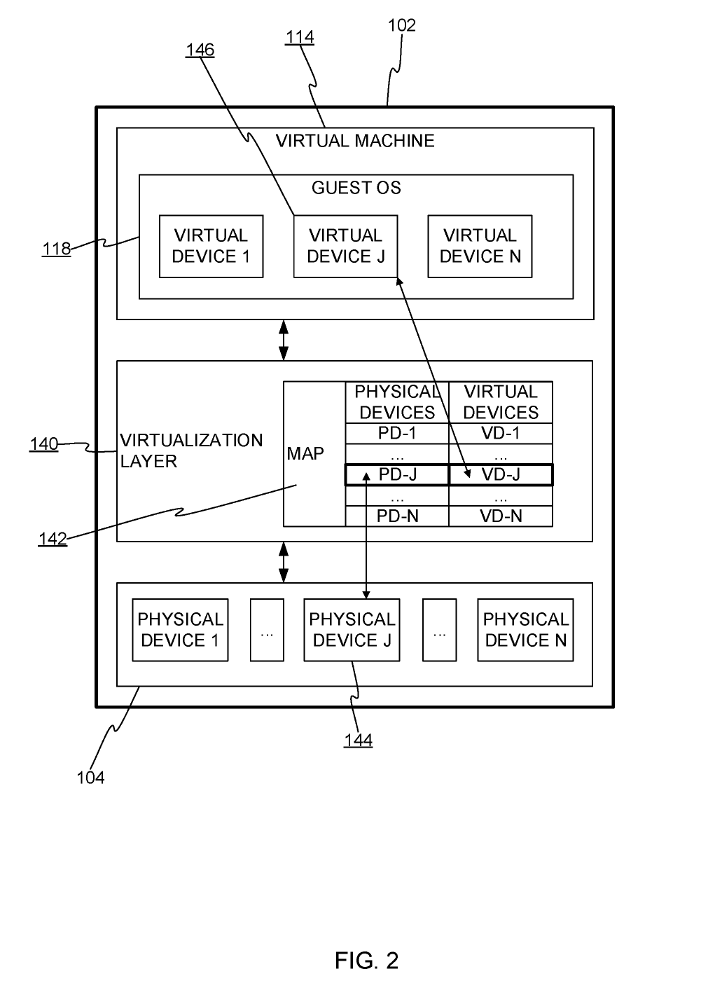

FIG. 2 shows how a virtualization layer 140 provides an indirection map 142 that maps physical devices (PDs) 144 to virtual devices 146. The physical/virtual devices may be a variety of device types and are typically devices that are driven by device drivers such as storage devices, network interface cards, graphics processing units, buses, etc. The virtualization layer 140 is any combination of hypervisor or virtualization kernel module as discussed above, and possibly other privileged components such as the host operating system 120. The virtualization layer 140 might be configured to support paravirtualization. The map 142 indicates which virtual devices 146 are associated with which physical devices 144. The map 142 will vary according to the implementation of the virtualization layer 140. The map 142 may be an actual data structure, or it may be embodied in the organization of the virtualization layer and the data it maintains for its VMs. Although FIG. 2 shows a one-to-one mapping between physical and virtual devices, in practice most maps will be a one-to-many map; a physical device may back multiple virtual devices. The physical devices 144 and virtual devices 146 may be represented by device identifiers of some sort, which might be, memory locations (e.g., pages), namespace entries, pointers to device objects, channel endpoints, input/output port numbers, etc. Physical device identifiers need not be device identifiers per se. Moreover, the types of handles used by the host to access physical devices (e.g., memory locations) might be different than the types of handles used by guests to access virtual devices (e.g., device identifiers). Similarly, the means of virtualizing access to physical devices may vary from one virtualization system to the next. Some virtualization systems may provide paravirtualization support that properly configured guests (e.g., drivers, kernels) can take advantage of for efficient device access. The paravirtualization approach is known and details may be found elsewhere.

FIG. 2 shows example physical device J mapped to example virtual device J. When the guest operating system 118 (for instance a device driver) interacts with virtual device J, the guest operating system 118 uses identifier VD-J in the map 142. When the virtualization layer 140 interacts with the corresponding physical device J, the virtualization layer 140 uses identifier PD-J in the map 142. The guest operating system 118 is unaware of the fact that interactions directed to VD-J are translated by the virtualization layer, per the map 142, to interactions with PD-J.

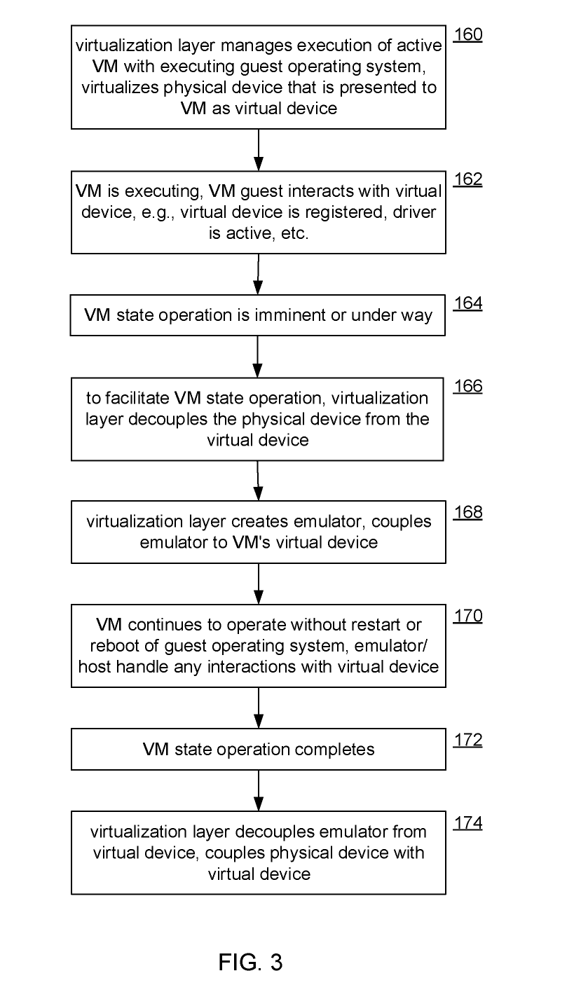

FIG. 3 shows a process for replacing the physical device J with an emulator in a way that is transparent to the guest operating system 118. The steps of FIG. 3 may vary in order for different embodiments. For instance, a convenient ordering may be: pausing VM's CPU cores, creating an emulator, decoupling the physical device, coupling the emulator, resuming the CPUs (total time in the hundreds of micro seconds). Another possible ordering is as follows.

Initially, at step 160, it is assumed that the virtualization layer 140 is managing execution of the VM 114, the guest operating system 118 is executing in the VM 114, the VM 114 is configured to interact with virtual device J via the VD-J handle/location/identifier, and the virtualization layer is mapping VM interactions with VD-J to PD-J, according to the map 142. At step 162, the VM is live and the guest operating system is configured to interact with virtual device J. For example, the virtual device J might be registered in a device tree, a device driver for virtual device J is executing in the VM, a VM-hypervisor channel might be in place for efficient conveyance of communications for physical/virtual device J between the guest operating system, etc. If a device driver in the guest operating system writes to VD-J, for instance, the virtualization layer transparently maps the write to PD-J.

At step 164, while the VM is live, a VM state operation is started at the virtualization layer. The VM state operation is any operation that relates to execution state of the VM, for instance pausing or saving execution state of the VM, migrating the VM, an administrator desiring to switch to emulation, etc. The VM state operation may be initiated in many ways. A network controller or cloud fabric might send a message to the host indicating which operation is to be performed on which VM. The host might initiate the operation based on a user command or a trigger event. In any case, the virtualization layer becomes aware of the VM state operation.

At step 166, in response to detection or initiation of the VM state operation, the virtualization layer decouples the physical device J from the virtual device J. That is, the virtualization layer logically disassociates the virtual device J from the VM 114. This may involve steps that are preferably transparent to the VM/guest. In one embodiment, the decoupling involves the virtualization layer changing the PD-J value in the PD-J↔VD-J mapping (map 142) to a new value that points to an emulator that emulates physical device J. In some embodiments, the physical device J is not necessarily affected or implicated; the physical device J is just logically decoupled by the remapping. In other embodiments, the physical device J might also be manipulated, as discussed below.

At step 168, an emulator is created by the virtualization layer. The emulator might be as simple as a memory or storage location for queueing interactions with the virtual device J while physical device J is decoupled from the virtual device J. The emulator might be a full device emulator that duplicates functionality of physical device J. The emulator might partially emulate the physical device J, for example implementing some functions of the physical device J but also having logic to accumulate requests that are not emulated. The emulator might have functions to communicate with the physical device J, perhaps through a corresponding driver interface, to enable transparent transition between one and the other backing the virtual device J. Regardless of the nature of the emulator, the emulator is coupled to the virtual device J by modifying virtual device J's mapping in map 142 to cause VD-J to be associated with an identifier/location for the emulator.

At step 170, the VM and the guest operating system substantially continue to operate without requiring a restart, reboot, or other operating change of the VM or the guest operating system (the guest is unaware of the change), and the emulator/host handle any interactions of the VM/guest with virtual device J. Regarding “substantially” continuing to operate, as will be discussed below, the virtualization layer might briefly suspend the VM (or one or more of its virtual CPUs) when the swap is performed, for instance to enable communication queues or channels to clear, to allow state of the physical device J to be transferred to the emulator, to provide a window for changing the association of the virtual device J, or for other periods when guest interaction with the virtual device J could be problematic. Thus, the VM/guest remains substantially online with perhaps a pause for any time (likely brief) needed to switch to the emulator. In a paravirtualization embodiment, the host and guest might communicate to assure that the guest does not attempt to use the virtual device during remapping.

At this point, the VM is online and executing under the control of the virtualization layer, and the guest operating system is also executing. The guest operating system still “sees” virtual device J and in the guest the VD-J valid handle/pointer remains valid, for instance for a driver in the guest operating system. The decoupling of the physical device J from the VM may facilitate completion of the VM state operation. For example, omission of the virtual device J might make a migration, pause, or save of the VM more efficient, complete, or robust. For example, if continuity of state of physical device J is maintained vis-a-vis the emulator, it might be more feasible to obtain a complete capture of execution state of the VM, thus facilitating a migration (and eventual coupling to another physical device) or a pause to allow a transparent reboot of the host, etc. For some virtualization systems, there may be many benefits as mentioned in the Background as well as general benefits from being able to get the physical device to stop its DMA activity and synchronize everything in the CPUs. If the guest attempts to interact with virtual device J, the emulator can take steps to keep the interaction valid, for instance by storing guest requests in a memory page/queue (to be supplied to physical device J or equivalent when it is coupled to virtual device J), by servicing requests to virtual device J (i.e., full emulation of physical device J), returning a valid rejection or error message, etc. In one embodiment, the emulator might be a trigger mechanism, e.g. a virtualization module, that detects or intercepts attempts to access virtual device J and responds by instructing the virtualization module to pause any virtual CPUs of the VM that might be affected by the unavailability of physical device J.

At step 172 the VM state operation completes and the guest's use of the physical device J may again become feasible. At step 174, steps described above may be reversed. State of the emulator might be transferred to the physical device J (or an equivalent), the physical device J may be coupled to virtual device J in the map 142, the emulator might be disposed, and so forth.

It should be noted that the steps above may vary in order. For example, the emulator might be created before or after decoupling the virtual device J. Some steps may be omitted. For example, a VM state operation might not be the impetus for the decoupling of virtual device J.

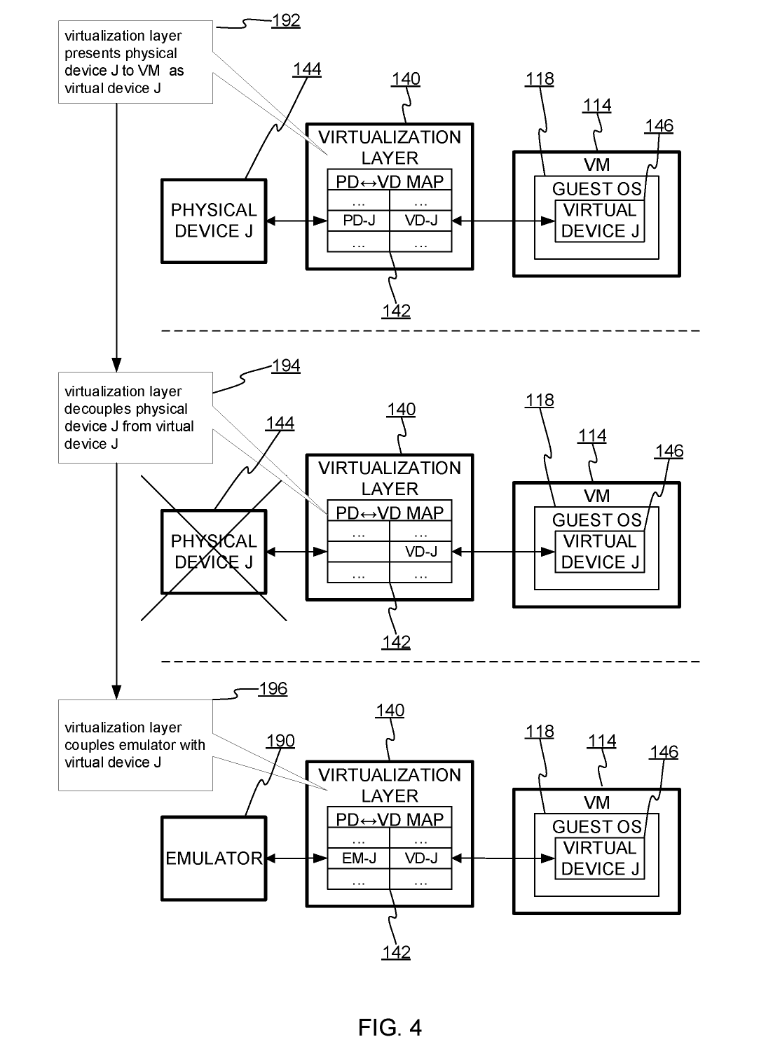

FIG. 4 shows the virtualization layer 140 replacing the physical device J with an emulator 190. As discussed above, the virtualization layer 140 virtualizes access to the physical device J for the VM 114 and guest operating system 118. At stage 192 the virtualization layer 192 is presenting the physical device J 144 as virtual device J 146. The guest operating system sees the physical device J as virtual device J. At stage 194 the virtualization layer decouples the physical device J from the VM 114, or more specifically, removes the physical device J from the map 142 so that the virtual device J is no longer backed by the physical device J. The guest operating system continues to “see” the virtual device J, although the VM might be briefly suspended to enable the transition to an emulator backing the virtual device. At stage 196 the virtualization layer couples an emulator 198 to the virtual device J by pointing the map entry for virtual device J to the emulator, perhaps also unsuspending the VM when finished.

In the case of a paravirtualized virtualization layer and an accordingly configured guest, the virtualization layer might enlist help from the guest to logically remove the physical device J. For example, the virtualization layer can be configured to signal the guest to quiesce or stop using the virtual device J, request a signal indicating when the device is not in use, or others.

In one embodiment, a formal emulator is not used and the physical device J is not logically decoupled from the virtual device J. Instead, guest integrity is maintained by the virtualization layer setting up a trigger on virtual device J to prevent use of the physical device J. For example, if the physical device J is accessed through a register or memory page, the hypervisor may protect the register or memory page by intercepting or preventing access. An access attempt by the VM might be handled by suspending the VM or one or more of its virtual CPUs.

Some types of physical devices may be more readily emulated than others. For instance, devices that implement published standards or protocols such as the Nonvolatile Memory Express (NVME™) standard may be emulated in straightforward way. When everything that a valid guest can ask of a device is known, emulation is a straightforward engineering task of duplicating functionality. In this case, the guest may see a degradation of performance but not functionality.

If a VM state operation is driving the decoupling of the physical device J, the virtualization layer may also have a process of evaluating the list of the VM's virtual devices and attempting to decouple as many of the physical devices mapped to the VM as possible.

As noted above, the function of an emulator may be as simple as, when the emulator is transparently swapped in, collecting and saving commands directed to the corresponding virtual device. When a corresponding physical device is to be coupled to the virtual device, the emulator pushes the queue to the physical device just before (or just after) the physical device is again available to the VM via the virtual device. This technique can be combined with capturing and restoring state of the physical device (through a host driver interface) to allow the VM to be live-migrated to a new host; a physical device on the new host is hydrated with the state and the queued commands are then provided to the physical device on the new host.

The techniques described above can be repeated to allow arbitrary switching between an emulated device and a physical device. That is, while a VM remains live and without any guest reboots, one of its virtual devices may transparently alternate between being backed by an emulator and being backed by a physical device. The techniques can also allow hot-swapping of physical devices. If a virtualization layer detects failure or expected failure of the physical device, an emulator can be hot-swapped in. If another physical device is available, the new physical device can then be hot-swapped into the VM.

In some embodiments, transparent switching may involve guest-host cooperation. For instance, to help with switching to an emulator, the virtualization layer might communicate with the guest to determine if the virtual device is idle. The virtualization layer may request a callback from a paravirtualization-aware guest when its virtual device is idle and time the emulator-swap accordingly. When switching to emulation, the virtualization layer may request a signal or callback when the virtual device is going to be accessed by the guest, thus enabling the virtualization layer to avoid or prevent conflicts.

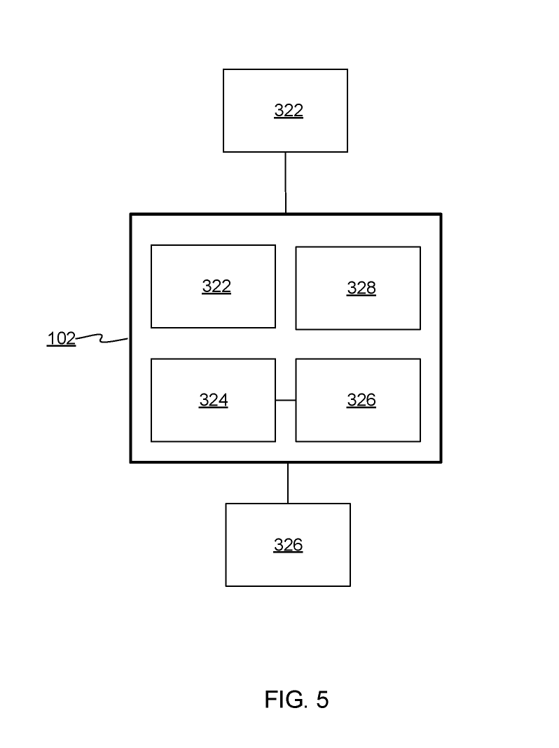

FIG. 5 shows details of the computing device 102 on which embodiments described above may be implemented. The technical disclosures herein will suffice for programmers to write software, and/or configure reconfigurable processing hardware (e.g., field-programmable gate arrays (FPGAs)), and/or design application-specific integrated circuits (ASICs), etc., to run on the computing device 220 to implement any of the features or embodiments described herein.

The computing device 102 may have one or more displays 322, a network interface 324 (or several), as well as storage hardware 326 and processing hardware 328, which may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 326 may be any combination of magnetic storage, static memory, volatile memory, non-volatile memory, optically or magnetically readable matter, etc. The meaning of the term “storage”, as used herein does not refer to signals or energy per se, but rather refers to physical apparatuses and states of matter. The hardware elements of the computing device 102 may cooperate in ways well understood in the art of machine computing. In addition, input devices may be integrated with or in communication with the computing device 102. The computing device 102 may have any form-factor or may be used in any type of encompassing device. The computing device 102 may be in the form of a handheld device such as a smartphone, a tablet computer, a gaming device, a server, a rack-mounted or backplaned computer-on-a-board, a system-on-a-chip, or others.

Embodiments and features discussed above can be realized in the form of information stored in volatile or non-volatile computer or device readable storage hardware. This is deemed to include at least hardware such as optical storage (e.g., compact-disk read-only memory (CD-ROM)), magnetic media, flash read-only memory (ROM), or any means of storing digital information in to be readily available for the processing hardware 228. The stored information can be in the form of machine executable instructions (e.g., compiled executable binary code), source code, bytecode, or any other information that can be used to enable or configure computing devices to perform the various embodiments discussed above. This is also considered to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method performed by a computer comprising processing hardware, storage hardware, and a hardware device, the method comprising:
executing a virtualization layer that provides VMs managed by the virtualization layer with virtual devices, wherein a VM managed by the virtualization layer comprises a guest OS configured to interact with a virtual device of the VM by the virtualization layer virtualizing access to the physical device via the virtual device, wherein the virtualization access is based on the virtualization layer maintaining a mapping between the virtual device and the physical device such that guest interactions with the virtual device are directed to the physical device; and
while the VM and the guest operating system are executing, updating the mapping to decouple the physical device from the virtual device such that the physical device no longer backs the virtual device.

2. A method according to claim 1, wherein the guest operating system comprises a first driver that drives the virtual device, and the virtualization layer comprises a hypervisor that comprises a second driver that drives the physical device.

3. A method according to claim 2, wherein the decoupling further comprises updating the mapping to map the virtual device to an emulator that then backs the virtual device.

4. A method according to claim 4, wherein the emulator emulates one or more functions of the physical device, and wherein the emulator replaces the physical device without requiring a restart of the VM and without requiring a restart of the guest operating system.

5. A method according to claim 1, wherein prior to the decoupling the mapping comprises an identifier or address of the virtual device and an identifier or address of the physical device, wherein after the decoupling the mapping comprises the identifier or address of the virtual device and an address or identifier of an emulator, and wherein requests from the virtual device pass to the virtualization layer through a communication channel between the virtualization layer and the VM.

6. A method according to claim 1, wherein the decoupling is performed in association with a state operation directed to the VM, the state operation comprises suspending, saving, or restoring execution state of the VM.

7. Computer storage hardware storing information configured to cause a computing device to perform a process, the computing device comprised of processing hardware and a physical device, the process comprising:
executing a hypervisor that manages execution of virtual machines (VMs) on the computing device, including a VM that comprises a guest operating system and a virtual device that the guest operating system is configured to interact with by directing device requests to the virtual device, wherein the hypervisor maps the devices requests to the physical device based on the hypervisor maintaining an association between the virtual device and an address of the physical device; and
while continuing to execute the VM and while the guest operating system continues to recognize the virtual device, updating the association to cause the virtual device to stop being associated with the physical device and thereafter continuing to execute the VM and the guest operating system.

8. Computer storage hardware according to claim 7, wherein updating the association further comprises associating the virtual device with an emulator that at least partially emulates the physical device.

9. Computer storage hardware according to claim 7, wherein updating the association further comprises associating the virtual device with an emulator that at least accumulates requests from the VM that are directed to the virtual device.

10. Computer storage hardware according to claim 7, wherein the virtualization layer comprises a first device driver for the physical device, the guest operating system comprises a second device driver for the virtual device, and wherein the second device driver continues to drive the virtual device before, during, and after the association with the physical device is stopped.

11. Computer storage hardware according to claim 7, wherein the stopping of the association is responsive to the hypervisor performing a VM state operation on the VM.

12. Computer storage hardware according to claim 7, the process further comprising temporarily suspending execution of the VM and/or a virtual processor thereof.

13. Computer storage hardware according to claim 7, the process further comprising transferring device state of the physical device to an emulator that replaces the physical device.

14. Computer storage hardware according to claim 7, the process further comprising updating the association to associate the virtual device with an emulator and based thereon directing requests directed to the virtual device to the emulator.

15. A computer comprising:
processing hardware;
a physical hardware device;
storage hardware storing, for execution by the processing hardware, a virtual machine (VM) and a virtualization layer;
the virtual machine (VM) comprising a virtual device and a guest operating system; and
the virtualization layer configured to virtualize access to the physical hardware device for the guest operating system via the virtual device by mapping the virtual device to the physical hardware device, the virtualization layer further configured to remap the virtual device from the physical hardware device to an emulator.

16. A computer according to claim 15, wherein the virtualization layer is configured to remap the virtual device to emulator without rebooting the VM and without rebooting the guest operating system.

17. A computer according to claim 15, wherein the virtualization layer is configured to remap the virtual device to emulator while the VM is being executed by the virtualization layer and while the guest operating system is executing.

18. A computer according to claim 17, wherein the remapping is transparent to the guest operating system.

19. A computer according to claim 15, wherein the guest operating system comprises a device driver configured to drive the virtual device, and wherein the device driver is configured to communicate with the virtual device while the virtual device is mapped to the physical hardware device and while the virtual device is mapped to the emulator.

20. A computer according to claim 15, wherein the virtualization layer is configured to, in order: pause a CPU core assigned to the VM, decouple the physical device from the virtual device, couple the emulator to the virtual device, and resume the CPU core.
